(19) United States
(12) Patent Application Publication
(10) Pub. No.: US 2026/0283882 A1
(43) Pub. Date: Sep. 24, 2026

(54) A MOLDABLE PAD FOR SUPPORTING A BODY PART

(71) Applicant: Mölnlycke Health Care AB, Mölndal (SE)

(72) Inventor: Fredrik Axelsson, Mölndal (SE)

(21) Appl. No.: 19/478,488

(22) PCT Filed: Apr. 10, 2024
(86) PCT No.: PCT/EP2024/059712

§ 371 Date: Oct. 24, 2025

(30) Foreign Application Priority Data
May 2, 2023 (EP) 23171031.0

(51) Int. Cl. A61G 7/057

(52) U.S. Cl. CPC A61G 7/05738

(57) ABSTRACT

Described is a moldable pad for supporting a body part; the moldable pad includes an outer shell enclosing a fluidized medium, wherein the outer shell has a top surface facing the body part, and an opposing bottom surface, wherein the moldable pad further includes at least one functional layer detachably attached to the top surface or the bottom surface of the outer shell, wherein the functional layer is a comfort layer or a friction-enhancing layer. Also described is a kit that includes the moldable pad.

### TECHNICAL FIELD

The present invention relates to a moldable pad for supporting a body part; the moldable pad comprising an outer shell enclosing a fluidized medium. The present invention also relates to a kit comprising the moldable pad.

### BACKGROUND

Pressure ulcers often arise among persons being bedridden for various reasons, such as for instance due to long term hospitalization or other causes of immobility. When the same location on the body is exposed to sustained pressure and shear, a pressure ulcer can develop in that location. Pressure ulcers are painful wounds that can develop quickly but tend to heal slowly.

In a hospital or care facility, caregivers adhere to specific protocols to prevent the occurrence of pressure ulcers. One important part in the prevention regimen is regular turning and re-positioning of the patient.

Various types of support mattresses exist on the market, which aim to prevent the formation of pressure ulcers. Such mattresses may comprise a gel, a foam or air to redistribute pressure under the body.

In order to assist patent re-positioning and to hold the patient in a desired protective position, a pressure redistribution pad may be utilized, either on its own, or in conjunction with the mattress.

One example of such a pressure redistribution pad is a fluidized positioner.

Fluidized positioners exist on the market, and typically comprise a fluidized medium. The fluidized medium preferably has no or limited shape memory such that the pad can conform to the skin of a patient in various positions.

The fluidized positioner may offload bony prominences on patients at risk of developing pressure ulcers. In use, the fluidized positioner may be arranged directly underneath a body part of a patient in a hospital bed. Alternatively, it may be used in conjunction with a mattress to angle a patient and hold the patient in a specific position for the purpose of pressure offloading.

A fluidized positioner may also be used for premature infants to support positioning of the infant's head and/or body. The fluidized positioner redistributes pressure over a greater surface area and can conform to the infant's head and body and create a “nest” or a cradle for the infant.

Existing fluidized positioners comprise an outer plastic shell which is filled with fluidized medium. The exterior plastic surface is moisture impermeable and not ideal for close contact with the skin of a patient. Existing fluidized positioners are typically single-use; i.e. after one positioner has been used for a specific patient and a specific care scenario, the positioner is discarded.

One challenge with existing fluidized positioner is that the plastic shell may cause the positioner to slide and move with respect to the surface of the bed and/or the mattress in use. In this regard, additional means may be required to hold the patient (and the fluidized positioner) in position.

Another challenge is that the plastic shell does not provide optimal comfort or microclimate when placed in direct contact with a patient's skin. For example, when used against the fragile skin of a neonatal, the plastic shell may be experienced as uncomfortable Furthermore, sweat precipitated from a patient's skin will not be absorbed or transported away.

In some hospitals, the caregivers may place the positioner in a conventional pillowcase to address this issue. However, such pillowcases do not overcome the challenges mentioned hereinbefore. Furthermore, conventional pillowcases may impair the moldability of the fluidized positioner and may cause the positioner to slide with respect to the pillowcase and with respect to the patient's skin.

To summarize, there is a need to provide an improved fluidized positioner which solves or at least alleviates the challenges mentioned hereinbefore.

### SUMMARY

In view of the above mentioned and other drawbacks of the prior art, it is an object of the present disclosure to provide improvements with respect to fluidized positioners when used for the purpose of patient re-positioning and/or for pressure offloading.

According to a first aspect of the present disclosure, there is provided a moldable pad for supporting a body part; the moldable pad comprising an outer shell enclosing a fluidized medium, wherein the outer shell of the moldable pad has a top surface facing the body part, and an opposing bottom surface, wherein the moldable pad further comprises at least one functional layer detachably attached to the top surface or the bottom surface of the outer shell, wherein the functional layer is a comfort layer or a friction-enhancing layer.

The functional layer of the moldable pad is detachably attached to the top surface or to the bottom surface of the outer shell. Hence, after the moldable pad has been used for a specific care scenario and for a specific patient, the functional layer may be removed and replaced with a new functional layer. This allows for the moldable pad to be used with more than one patient and in a variety of care scenarios. In other words, after the moldable pad has been used, the outer shell may be cleaned and/or disinfected, and a new functional layer may be attached.

The top surface of the outer shell is the surface facing the skin of the patient during use. The bottom surface of the outer shell is the surface facing away from the skin during use.

Typically, the functional layer forms the outermost layer of the moldable pad.

In embodiments where the functional layer is a comfort layer, the functional layer is preferably attached to the top surface of the outer shell. The comfort layer may thus be arranged in direct contact with the skin of the patient during use. The comfort layer may be referred to as a skin-contact layer.

In embodiments where the functional layer is a friction-enhancing layer, the functional layer is preferably attached to the bottom surface of the outer shell. The friction-enhancing layer is thus arranged in direct contact with the bed or the surface that the patient is lying on during use. The friction-enhancing layer prevents the moldable pad from sliding during use and holds the moldable pad in place, for example when a patient is turned and placed in a specific offloading position.

In exemplary embodiments, the functional layer is adhesively attached to the top surface or the bottom surface of the outer shell.

The adhesive attachment is beneficial as it allows for a firm attachment, yet the functional layer may be quickly and easily detached from and attached to the top or bottom surface of the outer shell.

In use, the functional layer should stay on firmly onto the surface of the outer shell of the moldable pad. This way, wrinkles are prevented from forming. Since the moldable pad of the present disclosure is typically used for patients at risk of developing pressure ulcers or for vulnerable neonatal babies, it is important to prevent wrinkles from forming. Wrinkles may enhance the friction against the skin, and give rise to undesirable shear forces and chafing, which could give rise to pressure ulcers or skin damage.

In exemplary embodiments, the functional layer has a first side facing the outer shell during use and a second, opposing side; the functional layer further comprising an adhesive layer arranged on the first side, wherein the adhesive layer is co-extensive in width and in length with the functional layer.

Accordingly, the adhesive layer extends across the first side of the functional layer. This way, wrinkles are prevented from forming during use. Furthermore, the functional layer conforms to the movement and molding of the moldable pad.

In exemplary embodiments, the functional layer is detachably attached to and extends across at least 70%, preferably at least 80% of the surface area of the top surface or the bottom surface of the outer shell.

In embodiments where the functional layer is a comfort layer, it is preferred that the functional layer covers a large surface area of the outer shell since this surface is to be arranged in contact with the skin of a wearer.

Preferably, the entire surface area of the top surface of the outer shell is covered by the functional layer. Hence, the adhesive layer may be detachably attached to and extend across the entire surface area of the top surface or the bottom surface of the outer shell. This way, no portions of the plastic outer shell will contact the skin of a patient.

In embodiments where the functional layer is a friction-enhancing layer, a large surface area of the bottom surface is also preferably covered. However, it is also conceivable that only a portion of the bottom surface of the outer shell is covered by the friction-enhancing layer, particularly if a high friction material is used.

In exemplary embodiments, the functional layer has a longitudinal (y) extension and a lateral (x) extension and comprises a material being stretchable in the longitudinal (y) and lateral (x) directions of extension.

The functional layer is preferably a stretchable material. If the functional layer is too stiff in the longitudinal (y) or lateral (x) directions of extension, the moldability of the pad may be impaired. A stretchable material allows the functional layer to conform to any contoured shape adopted by the moldable pad.

In exemplary embodiments, the functional layer is a comfort layer comprising a breathable material, and wherein the comfort layer is detachably attached to the top surface of the outer shell.

When the moldable pad is placed in direct contact with the skin of a patient, breathability is important to keep the patient comfortable and cool. This way, the microclimate is improved, and body fluids, such as sweat, or urine is more efficiently handled.

In exemplary embodiments, the functional layer is a comfort layer, wherein the comfort layer is absorbent.

Preferably, the comfort layer is absorbent. This way, the liquid handling properties of the moldable pad are significantly improved. A breathable and absorbent comfort layer improves the microclimate, which is important for pressure ulcer prevention.

In exemplary embodiments, the functional layer is a comfort layer comprising a polyurethane foam or a nonwoven material.

A polyurethane foam is beneficial since it is capable of absorbing large amounts of fluids, and also has a pressure relieving effect. The pressure relieving effect is beneficial to further prevent pressure ulcers from occurring. A polyurethane foam is also conformable and stretchable.

A nonwoven material has the ability to distribute fluid throughout the majority of the material such that the body liquid is evaporated across a larger surface area. The breathability of the functional layer (and the moldable pad) is thereby improved.

In exemplary embodiments, the functional layer is a friction-enhancing layer comprising a material having a coefficient of friction that is higher than the coefficient of friction of the outer shell of the moldable pad and wherein the functional layer is detachably attached to the bottom surface of the outer shell.

For example, the friction-enhancing layer may comprise a material having a static coefficient of friction that is at least three times higher, e.g. at least five times higher, preferably at least six times higher than the static coefficient of friction of the outer shell of the moldable pad.

Accordingly, the ability of the moldable pad to stay in place against the surface that the patient is resting on, e.g. a bed surface is significantly improved.

The enhanced friction against the bed surface secures that the moldable pad is prevented from sliding against the bed surface. Proper turning of the patient and pressure offloading is thereby accomplished. No additional means is required to hold the moldable pad in position.

In exemplary embodiments, the moldable pad comprises a first functional layer and a second functional layer; the first functional layer being a comfort layer detachably attached to the top surface of the outer shell; the second functional layer being a friction-enhancing layer detachably attached to the bottom surface of the outer shell.

Accordingly, the surface of the moldable pad being arranged against the skin of a patient during use provides comfort to the skin, whereas the surface of the moldable pad arranged in contact with the bed prevents the moldable pad from sliding.

This configuration is particularly preferred when the molded pad is used for re-positioning and pressure offloading without the aid of a pressure offloading mattress.

Preferably, the moldable pad has no shape memory.

Hence, the moldable pad may easily adopt a specific shape with little force, but retains its shape when the force is removed. This way, the moldable pad may be sculpted and may provide three-dimensional contouring to a body part during use. The pressure offloading effect is thereby improved.

In exemplary embodiments, the fluidized medium comprises a viscous fluid and a plurality of microparticles.

A viscous fluid is preferred to improve the moldability of the moldable pad.

The viscous fluid lubricates and coats the exterior surface of the microparticles, which are preferably microspheres and reduces the friction between the microparticles. A compact fluidized medium, which does not flow in the absence of a shear force, is thus accomplished.

The viscous fluid may be silicone oil or mineral oil.

According to another aspect, there is provided a kit comprising a moldable pad for supporting a body part; the moldable pad comprising an outer shell enclosing a fluidized medium, wherein the moldable pad has a top surface facing the body part, and an opposing bottom surface; the kit further comprising at least one functional layer configured to be detachably attached to the top surface or the bottom surface of the outer shell.

The functional layer preferably comprises an adhesive layer on the side configured to be arranged in contact with the outer shell. Prior to use, the adhesive layer may be protected by a release liner.

In exemplary embodiments, the kit further comprises a pressure offloading mattress.

Further features of, and advantages with, the present disclosure will become apparent when studying the appended claims and the following description. The skilled addressee realizes that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 is a cross-sectional view of a moldable pad according to an exemplary embodiment of the present disclosure.

FIG. 2a illustrates the step of applying a functional layer onto the outer shell of the moldable pad according to an exemplary embodiment of the present disclosure.

FIG. 2b illustrates the step of anchoring the functional layer onto the outer shell of the moldable pad according to an exemplary embodiment of the present disclosure.

FIG. 2c illustrates the step of shaping the moldable pad and the functional layer into a cradle for a neonatal infant.

FIG. 3 illustrates a neonatal infant positioned in a moldable pad according to an exemplary embodiment of the present disclosure, wherein the functional layer is a comfort layer arranged on the top surface of the outer shell.

FIG. 4a illustrates a care scenario where a patient is turned and positioned by means of a mattress and a moldable pad comprising a friction-enhancing functional layer arranged on the bottom surface of the moldable pad according to an exemplary embodiment of the present disclosure.

FIG. 4b is a zoomed in view illustrating a caregiver placing a moldable pad underneath a mattress and a patient, wherein the moldable pad comprises a friction-enhancing functional layer arranged on the bottom surface of the moldable pad according to an exemplary embodiment of the present disclosure.

### DETAILED DESCRIPTION

The present invention will now be described more fully hereinafter with reference to the accompanying drawings, in which currently preferred embodiments of the present invention are shown. The present invention may, however, be embodied in many different forms and should not be construed as limited to the embodiments set forth herein; rather, these embodiments are provided for thoroughness and completeness, and fully convey the scope of the present invention to the skilled person.

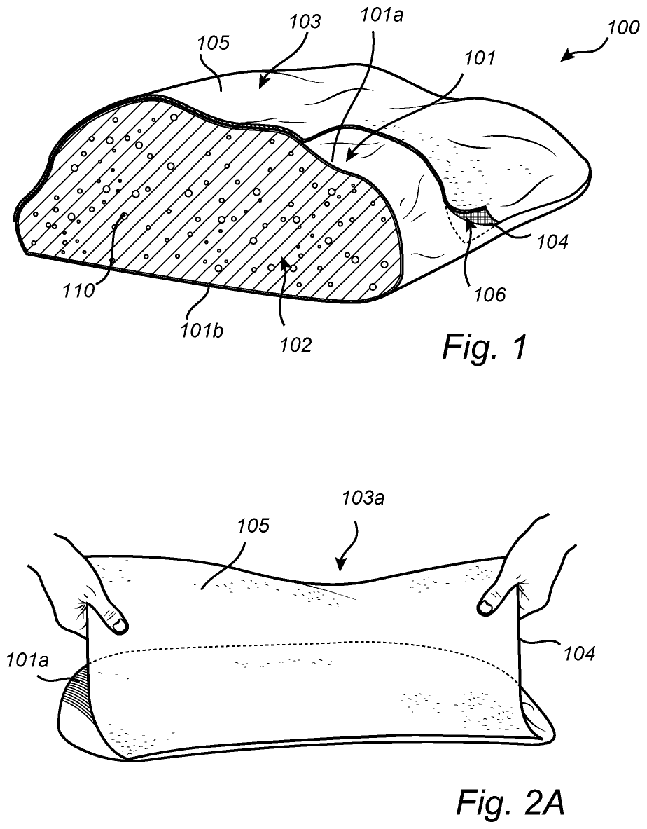

FIG. 1 illustrates a moldable pad 100 for supporting a body part; the moldable pad 100 comprising an outer shell 101 enclosing a fluidized medium 102, wherein the outer shell 101 has a top surface 101a facing the body part, and an opposing bottom surface 101b, wherein the moldable pad 100 further comprises at least one functional layer 103 detachably attached to the top surface 101a or the bottom surface 101b of the outer shell 101, wherein the functional layer 103 is a comfort layer or a friction-enhancing layer.

As used herein, the term “moldable pad” means that the pad may be molded into any shape upon the application of a force.

Preferably, the moldable pad has no shape memory. In other words, after the moldable pad has adopted a specific shape upon the application of a force, that shape is retained when the force is removed.

The outer shell 101 of the moldable pad may be any bladder or chamber in which the fluidized material may be enclosed. For example, the outer shell may be formed by two films or layers welded together along the peripheral edges of the films or layers.

The outer shell 101 has a top surface 101a and a bottom surface 101b. The top surface and the bottom surface may be defined between the welded peripheral edges of the films or layers forming the outer shell.

The outer shell 101 typically comprises a moisture and vapor impermeable material. The outer shell may comprise a plastic material such as a polymer based material, e.g. polyurethane, polyethylene etc.

The thickness of the outer shell 101 may be in the range of from 0.05 to 0.5 mm, preferably in the range of from 0.08 to 0.3 mm.

This range is desired to secure that the moldability of the pad is maintained while simultaneously securing that the fluidized medium is prevented from leaking out from the moldable pad during use. If the thickness of the outer shell is too high, this may restrict the moldability of the pad. If the thickness is too low, the risk of rupture of the outer shell during use is enhanced.

Typically, the outer shell 101 is formed from two polymer-based films, e.g. polyurethane films, welded together.

The moldable pad is not limited to a specific shape, but may be rectangular, square shaped or oval. Typically, the moldable pad is rectangular.

The moldable pad may have a width of from 10 to 80 cm, e.g. from 15 to 65 cm.

The moldable pad may have a length of from 20 to 120 cm, e.g. from 25 to 90 cm.

The size of the moldable pad may vary depending on the body part to be offloaded, the size and/or weight of the patient (adult or neonatal) etc.

As used herein, the term “fluidized medium” means a medium which flows under an applied shear force. The fluidized medium does not flow due to gravity. The fluidized medium is preferably shape retaining and may be pushed into a shape with very little force, but retain that shape when the force is removed.

The fluidized medium 102 comprises a viscous fluid, e.g. a viscous oil, e.g.

silicone oil or a mineral oil. The fluidized medium may further comprise microparticles having an average diameter less than 500 μm, e.g. an average diameter of from 10 to 300 μm.

The oil lubricates and coats the exterior surface of the microparticles and reduces the friction between the microparticles. A compact and firm medium, which does not flow in the absence of a shear force, is thus accomplished.

A viscous fluid means a fluid having a viscosity in the range of from 100 to 600 cSt, preferably from 200 to 400 cSt at a temperature of 20° C.

Preferably, the microparticles 110 are microspheres. The microspheres may be hollow phenolic, glass or plastic particles. Typically, the microspheres are hollow spherical particles with plastic walls.

The fluidized medium 102 may further comprise an additional lightweight material, such as foam beads. The foam beads may e.g. comprise polyethylene or polystyrene.

The moldable pad may e.g. be formed by filling an outer shell with a mixture of the viscous fluid and microparticles, e.g. microspheres, and subsequently removing gas, e.g. air by vacuum. The removal of gas may be varied and may affect the flow characteristics of the fluidized medium. For example, gas may be evacuated to achieve a subatmospheric pressure in the range of 5 to 500 mbar below ambient pressure.

The maximum thickness of the moldable pad may be in the range of from 10 to 250 mm, e.g from 20 to 200 mm. The thickness will vary depending on the use of the moldable pad. For example, a moldable pad intended to offload the back of an adult patient is typically thicker than a moldable pad intended to offload the head of a neonatal.

The outer shell 101 defines a top surface 101a and a bottom surface 101b. The top surface 101a is the surface facing the body part during use. The bottom surface 101b is the surface facing away from the body part during use. The bottom surface 101b faces the bed surface during use.

As illustrated in FIG. 1, the functional layer 103 is detachably attached to the top surface 101a of the outer shell 101.

As used herein, the term “detachably attached” means that functional layer may be peeled off from the outer shell of the moldable pad by hand. The functional layer is releasably connected to the outer shell and remains connected absent a separation force applied to the functional layer.

Preferably, the functional layer is adhesively attached to the top surface 101a or the bottom surface 101b of the outer shell 101.

The invention is not limited to the use of a specific adhesive as long as the adhesive allows the functional layer to be detached and removed from the outer shell of the moldable pad. For example, a hot-melt adhesive, an acrylate adhesive, a hydrocolloid adhesive, or a silicone-based adhesive may be utilized.

As illustrated in FIG. 1, the functional layer 103 has a first side 104 facing the outer shell 101 during use and a second, opposing side 105; the functional layer 103 further comprising an adhesive layer 106 arranged on the first side 104, wherein the adhesive layer 106 is co-extensive in width and in length with the functional layer 103.

Thus, the adhesive layer 106 extends across the first side 104 of the functional layer 103. The adhesive layer 106 may comprise perforations extending through the adhesive layer 106. Such perforations may reduce a too firm adhesion between the functional layer 103 and the outer shell 101.

The adhesive layer 106 secures that the functional layer 103 is fully attached to the outer shell 101 such that wrinkles are prevented from forming during use.

The functional layer 103 may be detachably attached to and extend across at least 70%, preferably at least 80% of the surface area of the top surface 101a or the bottom surface 101b of the outer shell 101.

Preferably, the functional layer 103 extends across the entire surface area of the top surface 101a of the outer shell 101. This is considered beneficial, particularly in embodiments where the functional layer is a comfort layer, as no part of the outer shell is then arranged in contact with the skin of a patient.

The functional layer 103 preferably comprises a stretchable material.

This is to secure that the functional layer conforms with the movement and the molding of the moldable pad.

The functional layer 103 may have a longitudinal (y) extension and a lateral (x) extension and comprises a material being stretchable in the longitudinal (y) and lateral (x) directions of extension.

For example, the functional layer 103 may comprise a material having a stretchability of at least 5%, e.g. at least 10% in the longitudinal (y) and lateral (x) directions of extension.

In exemplary embodiments, the functional layer 103 may have a tensile force of from 0.4 to 1.0 N at 20% strain, e.g. from 0.5 to 0.9 N at 20% strain, as measured by the test method ASTM D421.

In embodiments where the functional layer is a comfort layer, the functional layer preferably comprises a breathable material. In such embodiments, the comfort layer is detachably attached to the top surface of the outer shell.

The present disclosure is not limited to a specific material, but any breathable, soft, and skin-friendly material is conceivable.

It is also conceivable that the functional layer; i.e. the comfort layer 103a, is multi-layered.

For example, the comfort layer may comprise various layers laminated or adhesively attached to each other.

Preferably, the comfort layer 103a is also absorbent.

The comfort layer 103a may e.g. comprise a polyurethane foam or a nonwoven material.

These materials are skin-friendly and breathable and improve the comfort to the skin of a patient.

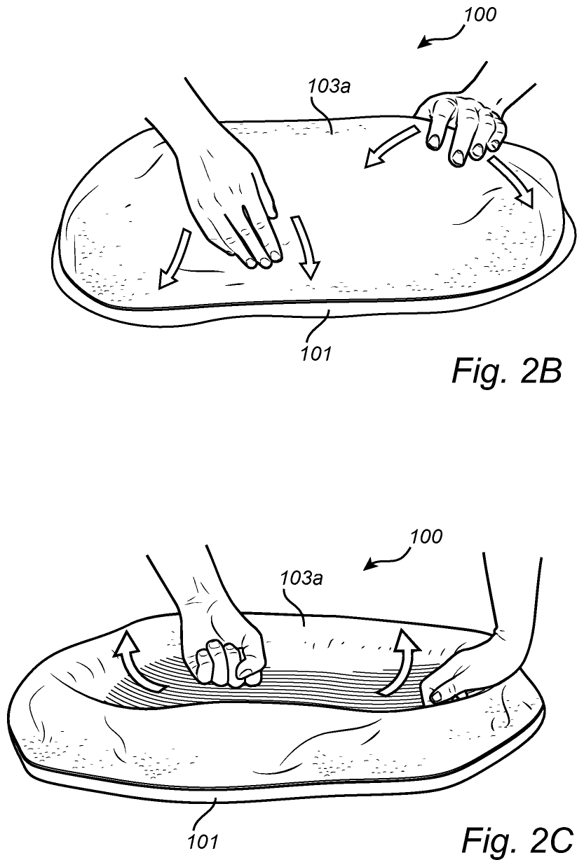

FIGS. 2a-2b illustrates the application of a comfort layer 103a onto the top surface 101a of the outer shell 101 of the moldable pad. The first side 104 of the comfort layer 103a; i.e. the side facing the outer shell 101 comprises an adhesive layer. Prior to application of the comfort layer, the adhesive layer may be covered with a protective release liner.

The comfort layer 103a is preferably attached to the entire surface area of the top surface 101a of the outer shell 101.

In FIG. 2c, the moldable pad is shaped into a cradle in which a neonatal infant is to be positioned. The comfort layer 103a molds with the moldable pad and conforms to the molded cradle shape.

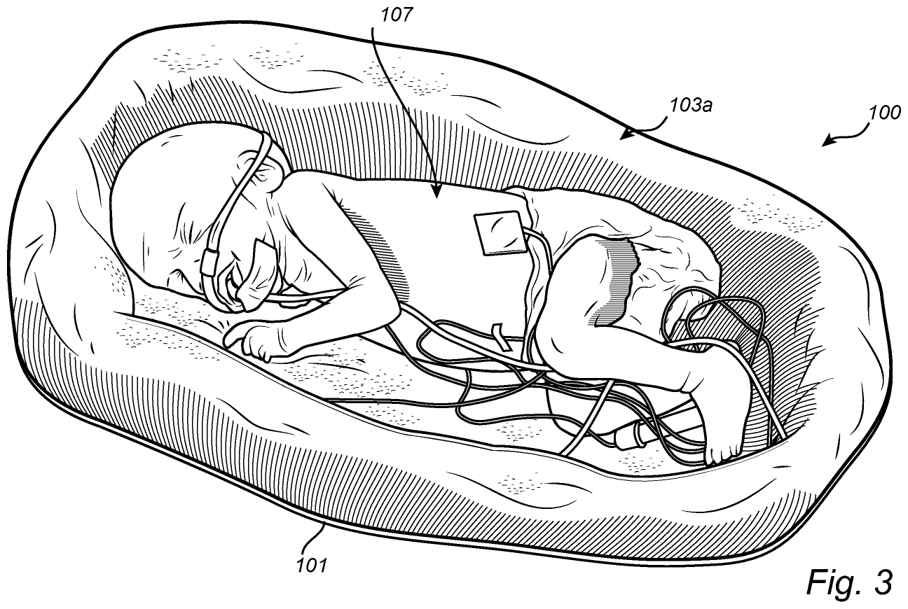

FIG. 3 illustrates a neonatal infant 107 positioned in the cradle, wherein the comfort layer 103a is arranged on the top surface of the outer shell. The comfort layer 103a comprises a skin-friendly and breathable material which provides comfort to the neonatal infant resting thereon.

The full adhesion between the outer shell 101 and the comfort layer 103a prevent undesired wrinkles from forming.

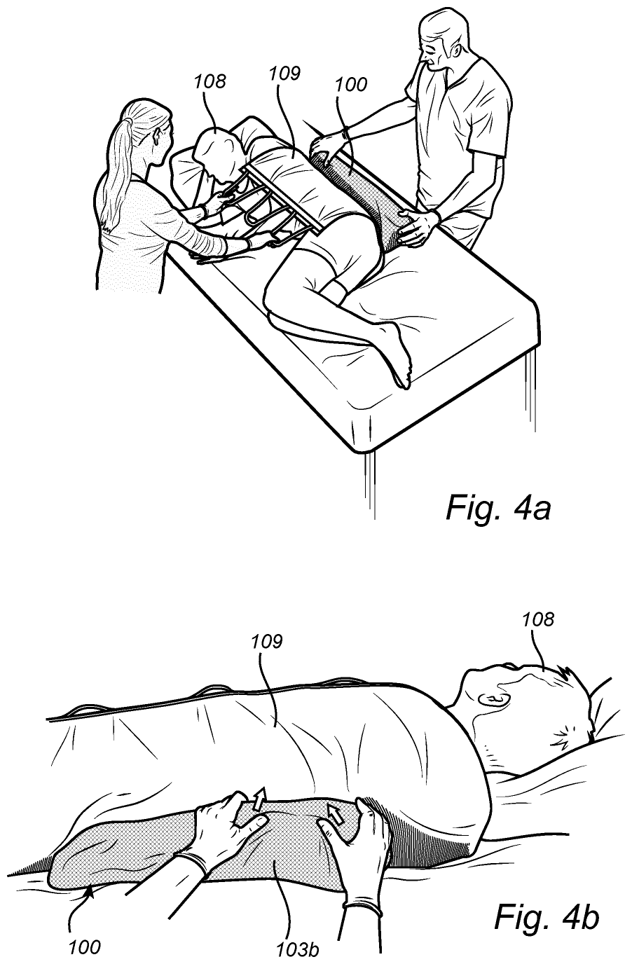

FIGS. 4a and 4b illustrate a care scenario where a patient 108 is turned and positioned by means of a mattress 109 and a moldable pad 100 comprising a friction-enhancing functional layer 103b arranged on the bottom surface of the outer shell.

The friction-enhancing layer 103b comprises a material having a static coefficient of friction that is higher than the static coefficient of friction of the outer shell of the moldable pad and wherein the functional layer is detachably attached to the bottom surface of the outer shell of the moldable pad.

In use, the friction-enhancing layer 103b secures that the moldable pad 100 is prevented from sliding against the bed surface and furthermore secures that the moldable pad 100 stays in place and provides pressure offloading.

It is also conceivable that the pressure offloading is performed by means of the moldable pad only; i.e. without the mattress 109.

In such embodiments, it is beneficial that the moldable pad also comprises a comfort layer arranged on the top surface of the outer shell of the moldable pad since the moldable pad will then be placed in direct contact with the skin of a patient.

It is furthermore conceivable that the top surface of the outer shell comprises a friction-enhancing layer 103b. This may be beneficial in embodiments where a pressure offloading mattress 109 is used in conjunction with the moldable pad.

Hence, the moldable pad may comprise a first friction-enhancing layer arranged on the bottom surface of the outer shell, and a second friction-enhancing layer arranged on the top surface of the outer shell. The first friction-enhancing layer enhances the friction between the moldable pad and the bed surface, whereas the second friction-enhancing layer enhances the friction between the moldable pad and the pressure off-loading mattress.

In exemplary embodiments, the friction-enhancing layer 103b may comprise a material having a static coefficient of friction that is at least three times higher, e.g. at least five times higher, preferably at least six times higher than the static coefficient of friction of the outer shell 101 of the moldable pad 100.

The static coefficient of friction of the material of the outer shell may be about 0.1, as measured according to ASTM D1894.

The friction-enhancing layer 103b may comprise a material having a static coefficient of friction of at least 1.0, as measured according to ASTM D1894.

If the coefficient of friction is high, it is conceivable with a smaller sized friction-enhancing layer. Hence, the functional layer may only cover a portion of the bottom surface of the outer shell.

The friction-enhancing material may be any non-skid material which increases the friction against an underlying surface. For example, the friction-enhancing material may comprise rubber.

It is also conceivable that the first side 104 of the friction-enhancing layer 103b (the side facing the bed surface during use) has been modified to enhance the friction. For example, the first side 104 of the friction-enhancing layer 103b may be textured. It is also conceivable that the first side 104 of the friction-enhancing layer 103b is slightly adhesive.

The moldable pad may comprise a first functional layer and a second functional layer; the first functional layer being a comfort layer detachably attached to the top surface of the outer shell; the second functional layer being a friction-enhancing layer detachably attached to the bottom surface of the outer shell.

As mentioned hereinabove, this is particularly beneficial when the moldable pad is utilized as a pressure off-loading pad without the presence of a mattress.

According to another aspect, there is provided a kit comprising a moldable pad 100 for supporting a body part; the moldable pad 100 comprising an outer shell 101 enclosing a fluidized medium 102, wherein the outer shell 100 has a top surface 101a facing the body part, and an opposing bottom surface 101b; the kit further comprising at least one functional layer 103 configured to be detachably attached to the top surface 101a or the bottom surface 101b of the outer shell 101.

The functional layer 103 may be a comfort layer or a friction-enhancing layer. In exemplary embodiments, the kit comprises both a comfort layer and a friction-enhancing layer.

The functional layer has a first side configured to face the outer shell during use. The first side is preferably provided with an adhesive layer. The adhesive layer is preferably covered by a release liner. The release liner is peeled off prior to application of the functional layer to the outer shell of the moldable pad.

The kit may further comprise a pressure offloading mattress 109.

The pressure offloading mattress may comprise a pressure offloading material such as air, foam or gel. Typically, the pressure offloading mattress comprises air.

Terms, definitions and embodiments of all aspects of the present disclosure apply mutatis mutandis to the other aspects of the present disclosure.

Even though the present disclosure has been described with reference to specific exemplifying embodiments thereof, many different alterations, modifications and the like will become apparent for those skilled in the art.

Variations to the disclosed embodiments can be understood and effected by the skilled addressee in practicing the present disclosure, from a study of the drawings, the disclosure, and the appended claims. Furthermore, in the claims, the word “comprising” does not exclude other elements or steps, and the indefinite article “a” or “an” does not exclude a plurality.

1. A moldable pad for supporting a body part; said moldable pad comprising an outer shell enclosing a fluidized medium, wherein said outer shell has a top surface facing said body part, and an opposing bottom surface, wherein said moldable pad further comprises at least one functional layer detachably attached to said top surface or said bottom surface of said outer shell, wherein said functional layer is a comfort layer or a friction-enhancing layer.

2. The moldable pad according to claim 1, wherein said functional layer is adhesively attached to said top surface or said bottom surface of said outer shell.

3. The moldable pad according to claim 1, wherein said functional layer has a first side facing said outer shell during use and a second, opposing side; said functional layer further comprising an adhesive layer arranged on said first side, wherein said adhesive layer is co-extensive in width and in length with said functional layer.

4. The moldable pad according to claim 1, wherein said functional layer is detachably attached to and extends across at least 70% of the surface area of said top surface or said bottom surface of said outer shell.

5. The moldable pad according to claim 1, wherein said functional layer has a longitudinal (y) extension and a lateral (x) extension and comprises a material being stretchable in the longitudinal (y) and lateral (x) directions of extension.

6. The moldable pad according to claim 1, wherein said functional layer is a comfort layer comprising a breathable material, and wherein said comfort layer is detachably attached to said top surface of said outer shell.

7. The moldable pad according to claim 1, wherein said functional layer is a comfort layer, and wherein said comfort layer is absorbent.

8. The moldable pad according to claim 1, wherein said functional layer is a comfort layer comprising a polyurethane foam or a nonwoven material.

9. The moldable pad according to claim 1, wherein said functional layer is a friction-enhancing layer comprising a material having a static coefficient of friction that is higher than the static coefficient of friction of said outer shell of said moldable pad, and wherein said functional layer is detachably attached to said bottom surface of said outer shell.

10. The moldable pad according to claim 9, wherein said friction-enhancing layer comprises a material having a static coefficient of friction that is at least three times higher than the static coefficient of friction of said outer shell of said moldable pad.

11. The moldable pad according to claim 1, wherein said moldable pad comprises a first functional layer and a second functional layer; said first functional layer being a comfort layer detachably attached to said top surface of said outer shell; said second functional layer being a friction-enhancing layer detachably attached to said bottom surface of said outer shell.

12. The moldable pad according to claim 1, wherein said moldable pad has no shape memory.

13. The moldable pad according to claim 1, wherein said fluidized medium comprises a viscous fluid and a plurality of microparticles.

14. A kit comprising a moldable pad for supporting a body part; said moldable pad comprising an outer shell enclosing a fluidized medium, wherein said outer shell has a top surface facing said body part, and an opposing bottom surface; said kit further comprising at least one functional layer configured to be detachably attached to said top surface or said bottom surface of said outer shell.

15. The kit according to claim 14, wherein said kit further comprises a pressure offloading mattress.
